(19) United States
(12) Patent Application Publication
(10) Pub. No.: US 2005/0230955 A1
(43) Pub. Date: Oct. 20, 2005

(54) Waterproof book

(75) Inventor: Takeru Mashimo, Tokyo-To (JP)

Correspondence Address: LADAS & PARRY, 26 WEST 61ST STREET, NEW YORK, NY, 10023, US

(73) Assignee: FRONTIER 2000 CO.,LTD.

(21) Appl. No.: 11/012,942

(22) Filed: Dec. 15, 2004

(30) Foreign Application Priority Data
Mar. 25, 2004 (JP) U 2004-1539

(51) Int. Cl. B42D 1/00

(52) U.S. Cl. 281/21.1

(57) ABSTRACT

A waterproof book can be read during bathing without trouble, is capable of maintaining its original shape, has leaves capable of maintaining the original shape and can be held by one hand for reading. The waterproof book includes: a necessary number of printed waterproof sheets forming leaves and each provided with a plurality of binding perforations on one edge thereof; and a binding member engaged in the binding perforations to bind the superposed waterproof sheets. The binding member has at least two binding loops capable of being closed after being loosely engaged in the two binding perforations of the superposed waterproof sheets, and a connecting part connecting the binding loops.

### BACKGROUND OF THE INVENTION

1. Field of the Invention

The present invention relates to a waterproof book intended to be read in a moist place, such as in a bathtub or by a swimming pool.

2. Description of the Related Art

Reading books during bathing has become popular for the effective use of time when a person soaks in the bathtub for a long time. A book held by a person soaked in the bathtub is moistened with steam sent up from the bathtub. Consequently, the paper leaves of the book are wrinkled and the book is deformed. Therefore, people hesitate to enter the bathroom with important books and people are able to read only books which can be unsparingly scrapped.

A book proposed in JP-U 4-113974 is capable of being read in a moist atmosphere around water or hot water without trouble. This known book is formed by binding waterproof leaves. This book is a saddle-stitched book formed by superposing waterproof leaves, and binding the superposed waterproof leaves at two positions on the center fold of the superposed waterproof leaves with metal wire staples. Although the waterproof leaves of this book will not wrinkle when exposed to steam and hence the book can be read in the bathtub without trouble, the waterproof leaves are liable to be distorted by heat and tend to open to spoil the shape of the book when exposed to steam because the book is saddle-stitched with the metal wire staples at the two position on the center fold of the superposed waterproof leaves. Consequently, the pages of the book cannot stably remain opened and hence a person to read the book is required to hold the right and the left page of the open book with both hands. Such work for holding the book will tire the bathing person. The book read in the bathroom and deformed due to the wrinkled waterproof leaves cannot be neatly closed. Thus the deformed book is difficult to store in an orderly fashion and is stored in a disorderly fashion. The metal wire staples binding the water-roof leaves are corroded and lose a binding function early and are unable to keep the book in its original shape for a long time.

### SUMMARY OF THE INVENTION

Accordingly, it is an object of the present invention to provide a waterproof book capable of being read without trouble by a bathing person, having an excellent shape retaining property, resistant to deformation, capable of being easily kept open for reading by one hand and having high durability.

A waterproof book in a first aspect of the present invention includes: a necessary number of printed waterproof sheets forming leaves and each provided with a plurality of binding perforations on one edge thereof; and a binding member engaged in the binding perforations to bind the superposed waterproof sheets; wherein the binding member has at least two binding loops loosely engaged in the binding perforations of the superposed waterproof sheets.

A waterproof book in a second aspect of the present invention includes: a necessary number of printed waterproof sheets forming leaves and each provided with a plurality of binding perforations on one edge thereof; and a binding member engaged in the binding perforations to bind the superposed waterproof sheets; wherein the binding member has at least two binding loops to be closed after being loosely engaged in the binding perforations of the superposed waterproof sheets, and a connecting part connecting the binding loops.

In the waterproof book according to the present invention, it is preferable that the connecting part serves as an elongate, flat spine, the binding loops are arranged longitudinally along an inner surface of the connecting part, and the connecting part and the binding loops are formed integrally of a synthetic resin such that respective free ends of the binding loops are in close contact with the outer surface of the connecting part.

In the waterproof book according to the present invention, it is preferable that the binding loops of the binding member loosely engaged in the binding perforations of the waterproof sheets are formed of a soft synthetic resin, each of the binding loops has two parts respectively having free ends capable of being joined together to close the binding loop.

In the waterproof book according to the present invention, it is preferable-that the connecting part of the binding member is used as an indicating part on which a title is printed directly or to which a label printed with a title is attached.

In the waterproof book according to the present invention, it is preferable that projections are formed in the opposite side edges of each of the binding loops.

In the waterproof book according to the present invention, it is preferable that the waterproof sheets are formed of a vinyl chloride resin in a thickness between 0.1 and 0.2 mm.

In the waterproof book according to the present invention, it is preferable that waterproof sheets are formed of a polyester resin in a thickness between 0.18 and 0.25 mm.

In the waterproof book according to the present invention, it is preferable that the waterproof sheets are formed by coating paper sheets with a synthetic resin.

In the waterproof book according to the present invention, it is preferable that the waterproof sheets are printed with desired characters, pictures and the like in UV inks.

In the waterproof book according to the present invention, it is preferable that surfaces of the waterproof sheets are embossed with patterns of irregularities such as grooves and ridges.

Preferably, the waterproof book according to the present invention is a book intended for reading during bathing.

Preferably, the waterproof book is a paperback book of a novel.

Preferably, the waterproof book is a book of go problems, chess problems or chess.

Preferably, the waterproof book is the Bible

The waterproof sheets forming the leaves of the waterproof book will not wrinkle even if the waterproof book is read in the bathtub and the waterproof sheets are moistened. Thus a person is able to enjoy reading the waterproof book in the bathtub and to turn the pages easily by smoothly turning the waterproof sheets along the binding loops to open the next page. The closed waterproof book can be neatly stored and will not deform even if the waterproof book is left in the bathroom.

Since the plurality of binding loops are connected by the connecting part, the waterproof sheets can be bound regularly, and the waterproof book is able to maintain its original shape and can be stably handled for storage and reading.

The connecting part, having a large area, of the binding member can be used as the spine of the waterproof book, and the title and the author of the waterproof book can be indicated on the connecting part to give the waterproof book a luxurious appearance. The connecting part of the binding member can be formed in the shape of a handle to facilitate carrying the waterproof book.

Indication of titles and the like on the outer surface of the connecting part of the binding member facilitates the management of the stored waterproof book and enables the quick finding of the stored waterproof book. Thus the waterproof book is suitable for use as a piece of amusement equipment at hot-spring resorts and public baths.

Since the binding loops prevent the waterproof sheets from random movement, the waterproof book can be stably held by hand for reading.

The waterproof sheets are inexpensive and resistant to heat of about 80° C. Therefore, any troubles will not arise even if the waterproof book is read during bathing in the bathtub. The waterproof book is not very thick and not difficult to read even if the waterproof book has about three hundreds pages (one hundred and fifty waterproof sheets).

The waterproof sheets formed of the polyester resin have high heat resistance. The waterproof book having the waterproof sheets each formed by coating a paper sheet with a synthetic resin has a luxurious appearance. The characters, pictures and the like printed in UV inks do not spread even in a moist atmosphere and remain clear permanently.

The binding member of the synthetic resin can be formed by molding at low costs, the binding member of the synthetic resin is inexpensive, corrosion-resistant and capable of maintaining the original shape of the waterproof book for a long time. Thus the waterproof book of the present invention can be kept in domestic bathrooms, and public bathrooms of hot-spring hotels.

### BRIEF DESCRIPTION OF THE DRAWINGS

The above and other objects, features and advantages of the present invention will become more apparent from the following description taken in connection with the accompanying drawings, in which:

FIG. 1 is a perspective view of a waterproof book in a first embodiment according to the present invention;

FIG. 2 is a sectional view taken on the line A-A in FIG. 1;

FIGS. 3(A) and 3(B) are front elevations of an open binding loop and a closed binding loop, respectively;

FIG. 4 is a perspective view of a waterproof book in a second embodiment according to the present invention;

FIG. 5 is a sectional view taken on the line B-B in FIG. 4;

FIG. 6 is a fragmentary, perspective view of a binding member included in the waterproof book shown in FIG. 4;

FIG. 7 is a partly cutaway perspective view of the spine of the waterproof book shown in FIG. 4;

FIG. 8 is a perspective view of a binding member; and

FIG. 9 is a front elevation of a binding loop.

### DESCRIPTION OF THE PREFERRED EMBODIMENTS

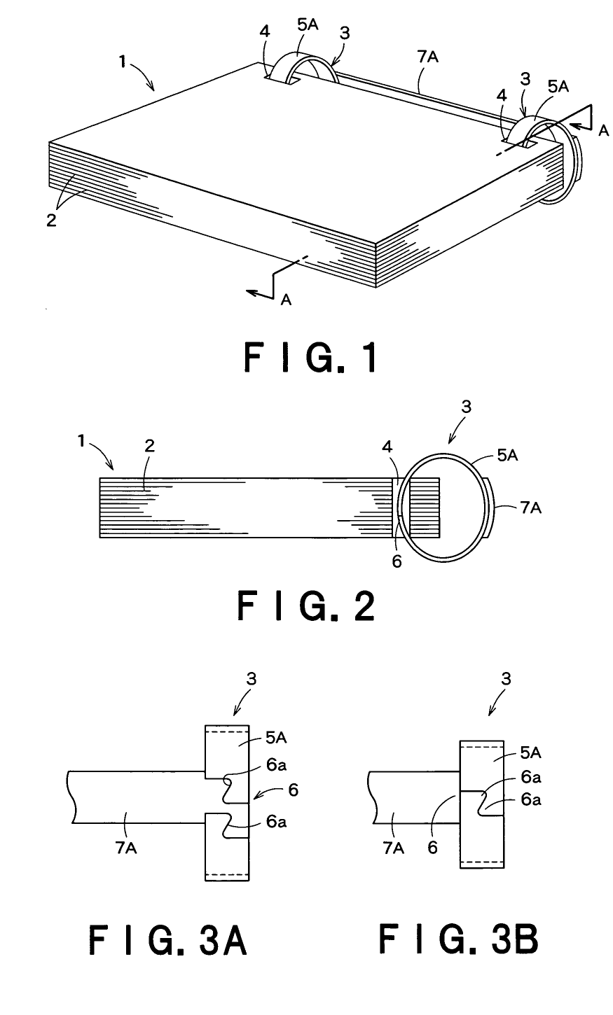

Referring to FIGS. 1 to 3, a waterproof book 1 in a first embodiment according to the present invention includes a plurality of rectangular waterproof sheets 2 of 148 mm×105 mm, and a binding member 3 engaged with back edges of the waterproof sheet 2 to bind the waterproof sheets 2. The waterproof sheets 2 are formed of heat-resistant synthetic resin, such as a vinyl chloride resin or a polyester resin. Each of the waterproof sheets 2 is provided in its long edge with two binding perforations 4. The binding member 3 for binding the waterproof sheets 2 has two binding loops 5A to be engaged in the binding perforations 4, and a connecting part 7A. Each of the binding loops 5A has an openable joint 6.

Referring to FIGS. 3(A) and 3(B), the binding loop 5A has first and second end parts 6a. The first and the second end part 6a of the binding loop 5A are joined to form the joint 6. The edges of the first and the second end part 6a are formed in complementary Z-shapes, respectively, such that the Z-shaped edges of the first and the second end part 6a are engaged closely with each other to form the closed binding loop 5A. The first end part 6a of the binding loop 5A may be provided with a projection, the second end part 6a may be provided with an opening, and the projection of the first end part 6a may be pressed in the opening of the second end part 6a to form the closed binding loop 5A.

Preferably, the thickness of the waterproof sheets 2 is between 0.1 and 0.2 mm when the waterproof sheets 2 are formed of a vinyl chloride resin or between 0.18 and 0.25 mm when the waterproof sheets 2 are formed of a polyester resin. When necessary, the waterproof book 1 may include waterproof sheets thicker than the waterproof sheets 2 and serving as front and back covers.

When the binding member 3 has the two binding loops 5A as shown in FIG. 1, parts of the binding loops 5A opposed to the joints 6 may be formed integrally with the connecting part 7A. The binding loops 5A are formed on the inner surface of the connecting part 7A, are spaced a predetermined distance apart and are set in a predetermined position on the connecting part 7A. A title and the like may be printed directly on or a label printed with a title and the like may be attached to the outer surface of the connecting part 7A of the binding member 3.

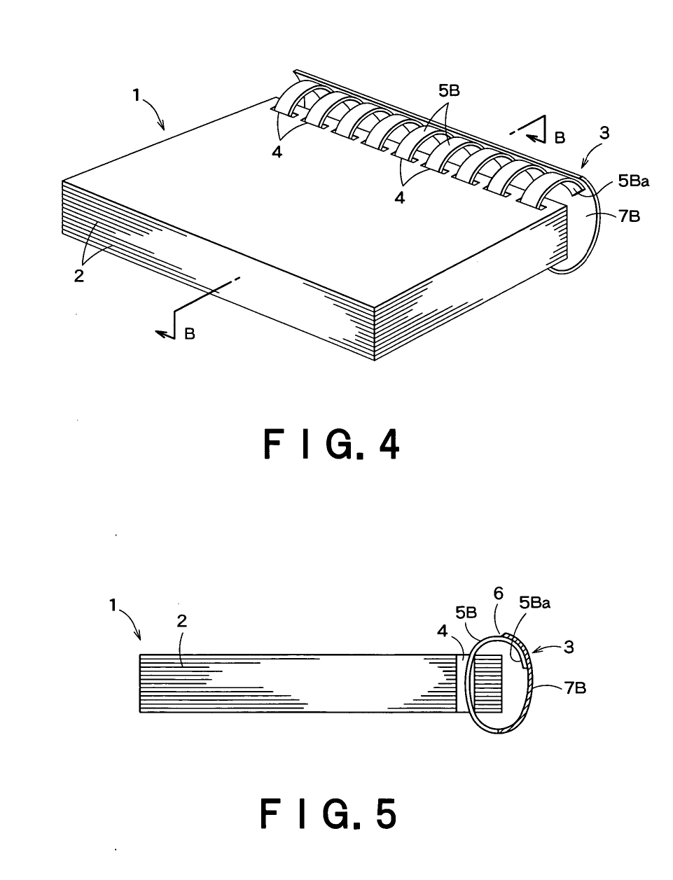

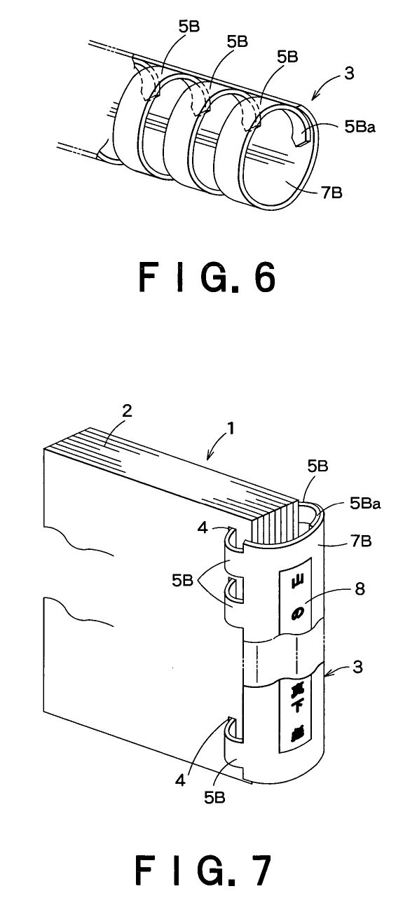

Referring to FIGS. 4 to 7, a waterproof book 1 in a second embodiment according to the present invention includes a plurality of rectangular waterproof sheets 2 and a binding member 3 engaged with back edges of the waterproof sheet 2 to bind the waterproof sheets 2. The binding member 3 has a long, flat connecting part 7B serving as the spine of the waterproof book 1, and a plurality of binding loops 5B arranged at equal intervals on the inner surface of the connecting part 7B. The waterproof sheets 2 are provided on the back edges thereof with binding perforations 4 formed at pitches equal to those of the binding loops 5B. The number of the binding perforations 4 is equal to that of the binding loops 5B. Longitudinal side edges of the connecting part 7B are curved. The binding loops 5B have-end parts 5Ba curved in a shape conforming to the curved longitudinal side edge of the connecting part 7B. The end parts 5Ba of the binding loops 5B are elastically pressed against the inner surface of the connecting part 7B. Thus, the binding member 3 has an elliptic or oval cross section.

As shown in FIG. 7, the connecting part 7B having a large area covers the back edges of the waterproof sheets 2 to give a nice appearance of a book. The outer surface of the connecting part 7B can be used as an indicating part 8. The title and the author of the waterproof book 1 can be printed directly on the indicating part 8 of the connecting part 7B or a label printed with the title and the author of the waterproof book 1 can be attached to indicating part 8 of the connecting part 7B. The use of the outer surface of the connecting part 7B as the indicating part 8 facilitates finding the stored waterproof book 1.

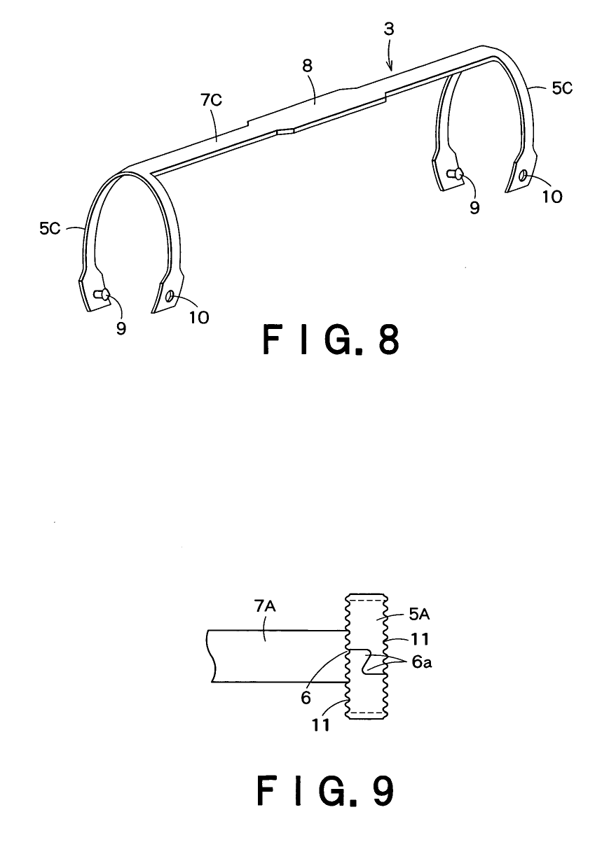

FIG. 8 shows a possible binding member 3 having a connecting part 7C and binding loops 5C formed integrally with the connecting part 7C at the opposite ends, respectively, of the connecting part 7C. Each of the binding loops 5C has thin first and second parts. The first and the second part of the binding loop 5C are provided in their end parts with a headed projection 9 and an opening 10, respectively. The headed projection 9 is pressed in the opening 10 to close the binding loop 5C. Part of the outer surface of the connecting part 7C is used as an indicating part 8. The connecting part 7C may be used as a handle for carrying the waterproof book 1 by hand.

FIG. 9 shows another possible binding member provided with binding loops 5A similar to the binding loops 5A shown in FIG. 1 by way of example. Each of the binding loops 5A is provided in its side edges with small projections 11 to restrain the waterproof sheets 2 from free movement when the waterproof book 1 is opened. The binding loops 5A shown in FIG. 9 increase the stability of the bound waterproof sheets 2, restrain the waterproof sheets 2 from free movement when the waterproof book 1 is held for reading and facilitate holding the waterproof book 1.

Characters, pictures and the like are printed on the waterproof sheets 2 in UV inks. The characters, pictures and the like printed in UV inks (UV-curable inks) do not spread even in a moist atmosphere and remain clear permanently. The waterproof sheets 2 may be those formed by coating paper sheets with a synthetic resin.

When it is desired to prevent the waterproof sheets 2 having smooth surfaces of the waterproof book 1 of the present invention from sticking to each other when the waterproof book 1 is dropped in hot water contained in a bathtub, the surfaces of the waterproof sheets 2 may be roughened by forming fine grooves or irregularities therein by embossing. The embossed surfaces of the waterproof sheets 2 will secure minute gaps between the adjacent waterproof sheets 2 to prevent the adjacent waterproof sheets 2 from sticking to each other.

Although the waterproof book may be a paperback book of a novel, waterproof books useful for provoking persons into thinking during bathing, such as waterproof books of go problems, chess problems and chess, will be effective for the effective use of bathing time and in activating the readers' brains. The waterproof book is particularly effective when a person bathes for a long time in a half-body bathing mode.

The waterproof book may be the Bible. The waterproof Bible enables a person to mediate on the-teaching of the Bible and to consider the wording of the Bible deeply.

1. A waterproof book comprising:
a necessary number of printed waterproof sheets forming leaves and each provided with a plurality of binding perforations on one edge thereof; and
a binding member engaged in the binding perforations to bind the superposed waterproof sheets;
wherein the binding member has at least two binding loops loosely engaged in the binding perforations of the superposed waterproof sheets.

2. A waterproof book comprising:
a necessary number of printed waterproof sheets forming leaves and each provided with a plurality of binding perforations on one edge thereof; and
a binding member engaged in the binding perforations to bind the superposed waterproof sheets;
wherein the binding member has at least two binding loops capable of being closed after being loosely engaged in the two binding perforations of the superposed waterproof sheets, and a connecting part connecting the binding loops.

3. The waterproof book according to claim 2, wherein the connecting part serves as an elongate, flat spine,
the binding loops are arranged longitudinally along an inner surface of the connecting part, and
the connecting part and the binding loops are formed integrally of a synthetic resin such that respective free ends of the binding loops are in close contact with an outer surface of the connecting part.

4. The waterproof book according to claim 2, wherein the binding loops of the binding member loosely engaged in the binding perforations of the waterproof sheets are formed of a soft synthetic resin, each of the binding loops has two narrow pales respectively having fi-ee ends capable of being joined together to close the binding loop.

5. The waterproof book according to claim 2, wherein the connecting part of the binding member is used as an indicating pair on which a title is printed directly or to which a label printed with a title is attached.

6. The waterproof book according to claim 1, wherein projections are formed in opposite side edges of each of the binding loops.

7. The waterproof book according to claim 1, wherein the waterproof sheets are formed of a vinyl chloride resin in a thickness between 0.1 and 0.2 mm.

8. The waterproof book according to claim 1, wherein the waterproof sheets are formed of a polyester resin in a thickness between 0.18 and 0.25 mm.

9. The waterproof book according to claim 1, wherein the waterproof sheets are formed by coating paper sheets with a synthetic resin.

10. The waterproof book according to claim 1, wherein the waterproof sheets are printed with desired characters, pictures and the like in UV inks.

11. The waterproof book according to claim 1, wherein surfaces of the waterproof sheets are embossed with patterns of irregularities such as grooves and ridges.

12. The waterproof book according to claim 1, is a book intended for read during bathing.

13. The waterproof book according to claim 1, is a paperback book of a novel.

14. The waterproof book according to claim 1, is a book of go problems, chess problems or chess.

15. The waterproof book according to claim 1, is the Bible.
